(19) United States
(12) Patent Application Publication
(10) Pub. No.: US 2025/0088819 A1
(43) Pub. Date: Mar. 13, 2025

(54) ORIENTATION SENSOR AXIAL SELF-CALIBRATION

(71) Applicant: Bose Corporation, Framingham, MA (US)

(72) Inventors: Thomas Landemaine, Cambridge, MA (US); Wade P. Torres, Attleboro, MA (US)

(73) Assignee: Bose Corporation, Framingham, MA (US)

(21) Appl. No.: 18/465,691

(22) Filed: Sep. 12, 2023

(51) Int. Cl. H04S 7/00; H04R 1/10; H04R 5/033

(52) U.S. Cl. CPC H04S 7/304; H04R 1/1016; H04R 1/1041; H04R 5/033; H04R 2499/11

(57) ABSTRACT

A method for calibrating the axial alignment of orientation sensors, includes: receiving a first orientation signal representative of an orientation of a first earpiece of a pair of earphones, the first orientation signal being relative a first orientation axes of the first orientation sensor; receiving a second orientation signal representative of an orientation of a second earpiece of the pair of headphones, the second orientation signal being relative a second orientation axes of the second orientation sensor; calculating a mapping between the first orientation sensor axes and the second orientation sensor axes according to a difference between the first orientation signal and the second orientation signal; calibrating the first orientation axes according to a midpoint of the mapping; and calibrating the second orientation axes according to an inverse of the midpoint of the mapping

### BACKGROUND

This disclosure relates to earphones configured to self-calibrate the axial alignment of its orientation sensors and a method for calibrating the axial alignment of orientation sensors disposed within earphones.

### SUMMARY

All examples and features mentioned below can be combined in any technically possible way.

According to an aspect, pair of earphones with orientation sensor axial alignment self-calibration, includes: a first earpiece housing a first orientation sensor, the first orientation sensor outputting a first orientation signal, wherein the first orientation signal is representative of an orientation of the first earpiece and is relative a first orientation axes of the first orientation sensor; a second earpiece housing a second orientation sensor, the second orientation sensor outputting a second orientation signal, wherein the second orientation signal is representative of an orientation of the second earpiece and is relative to a second orientation axes of the second orientation sensor; a controller configured to calculate a mapping between the first orientation sensor axes and the second orientation sensor axes according to a difference between the first orientation signal and the second orientation signal, wherein the controller is further configured to calibrate the first orientation axes according to a midpoint of the mapping and calibrate the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

In an example, the mapping is calculated according to an adaptive algorithm.

In an example, the mapping is calculated non-adaptively.

In an example, the first orientation sensor and the second orientation sensor are each inertial measurement units.

In an example, the first orientation sensor and the second orientation sensor each comprise at least one gyroscope sensor.

In an example, the first orientation sensor and the second orientation sensor are disparate sensor types, wherein the first orientation sensor is an accelerometer and a gyroscope sensor, wherein the second orientation sensor is an accelerometer.

In an example, the controller is housed in at least one of a first earpiece or the second earpiece.

In an example, the controller is further configured to render a spatialized audio signal according to the calibrated first orientation signal and the calibrated second orientation signal.

In an example, the spatialized audio signal is determined according to a spatialized audio algorithm, the spatialized audio algorithm including an interaural time difference parameter, wherein the controller is further configured to adjust the interaural time difference parameter according to a vector representing a distance between the first orientation sensor and the second orientation.

According to another aspect, a method for calibrating the axial alignment of orientation sensors includes: receiving a first orientation signal representative of an orientation of a first earpiece of a pair of earphones, the first orientation signal being relative a first orientation axes of a first orientation sensor; receiving a second orientation signal representative of an orientation of a second earpiece of the pair of headphones, the second orientation signal being relative a second orientation axes of a second orientation sensor; calculating a mapping between the first orientation sensor axes and the second orientation sensor axes according to a difference between the first orientation signal and the second orientation signal; calibrating the first orientation axes according to a midpoint of the mapping; and calibrating the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

In an example, the mapping is calculated according to an adaptive algorithm.

In an example, the mapping is calculated non-adaptively.

In an example, the first orientation sensor and the second orientation sensor are each inertial measurement units.

In an example, the first orientation sensor and the second orientation sensor each comprise at least one angular rate sensor.

In an example, the at least one angular rate sensor is a gyroscope sensor.

In an example, the first orientation sensor and the second orientation sensor are disparate sensor types, wherein the first orientation sensor is an accelerometer and a gyroscope sensor, wherein the second orientation sensor is an accelerometer.

In an example, the method further includes, rendering a spatialized audio signal according to the calibrated first orientation signal and the calibrated second orientation signal, wherein the spatialized audio signal is determined according to a spatialized audio algorithm, the spatialized audio algorithm including an interaural time difference parameter, and adjusting the interaural time difference parameter according to a vector representing a distance between the first orientation sensor and the second orientation.

According to another aspect, at least one non-transitory storage medium storing program code for execution on at least one processor that, when executed, calibrates the axial alignment of a pair of orientation sensors, includes: receiving a first orientation signal representative of an orientation of a first earpiece of a pair of earphones, the first orientation signal being relative a first orientation axes of the first orientation sensor; receiving a second orientation signal representative of an orientation of a second earpiece of the pair of headphones, the second orientation signal being relative a second orientation axes of a second orientation sensor; calculating a mapping between the first orientation sensor axes and the second orientation sensor axes according to a difference between the first orientation signal and the second orientation signal; calibrating the first orientation axes according to a midpoint of the mapping; and calibrating the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

In an example, the mapping is calculated according to an adaptive algorithm.

In an example, the mapping is calculated non-adaptively.

In an example, the first orientation sensor and the second orientation sensor are each inertial measurement units.

The details of one or more implementations are set forth in the accompanying drawings and the description below. Other features, objects, and advantages will be apparent from the description and the drawings, and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various aspects.

FIG. 1A depicts a front view and the associated axes of a human head.

FIG. 1B depicts a top view and the associated axes of a human head.

FIG. 2A depicts a front view and the associated axes of a pair of earbuds worn in the aligned orientation.

FIG. 2B depicts a front view and the associated axes of a pair of earbuds worn rolled inward.

FIG. 2C depicts a front view and the associated axes of a pair of earbuds worn rolled outward.

FIG. 3A depicts a top view and the associated axes of a pair of earbuds worn in the aligned orientation.

FIG. 3B depicts a top view and the associated axes of a pair of earbuds adjusted inward

in yaw.

FIG. 3C depicts a top view and the associated axes of a pair of earbuds adjusted outward in yaw.

FIG. 4 depicts a block diagram of a pair of earphones configured with orientation sensor axial self-calibration, according to an example.

FIG. 5 depicts a method for calibrating the axial alignment of orientation sensors associated with a pair of earphones, according to an example.

### DETAILED DESCRIPTION

Earphones are often equipped with orientation sensors (e.g., inertial measurement units) that detect and report data from which the orientation of the earphone can be determined. The information is used to provide, for example, spatialized audio—i.e., audio that is perceived by the user to be originating from at least one location distinct from the actual location of the electroacoustic transducers within the earphones or earbuds. More particularly, detected changes in orientation of the earphones and earbuds will correspond to changes in the orientation of the user's head. This information can be leveraged to adjust the acoustic signals delivered to the user to simulate the changes in acoustic signals that would occur if the acoustic signal originated from a virtual source. The result is that, as the user's head turns, the user perceives the audio as originating from the virtual source, rather than from the transducers located within the earbuds or earphones.

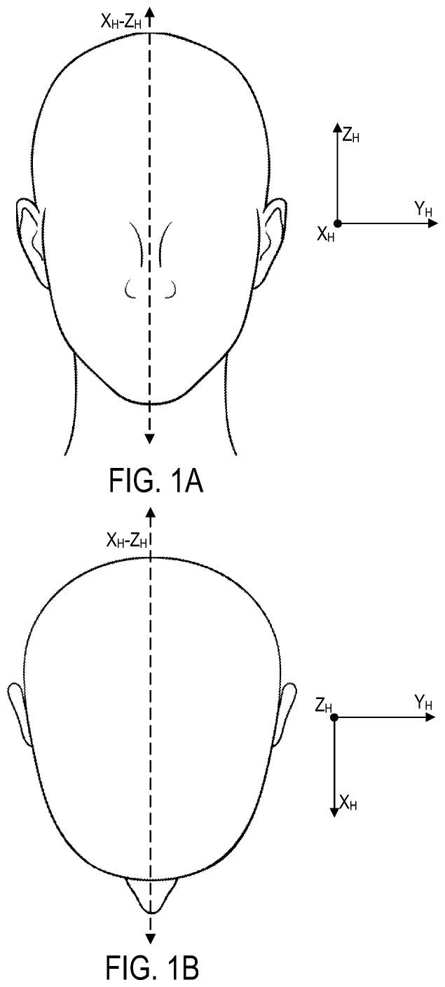

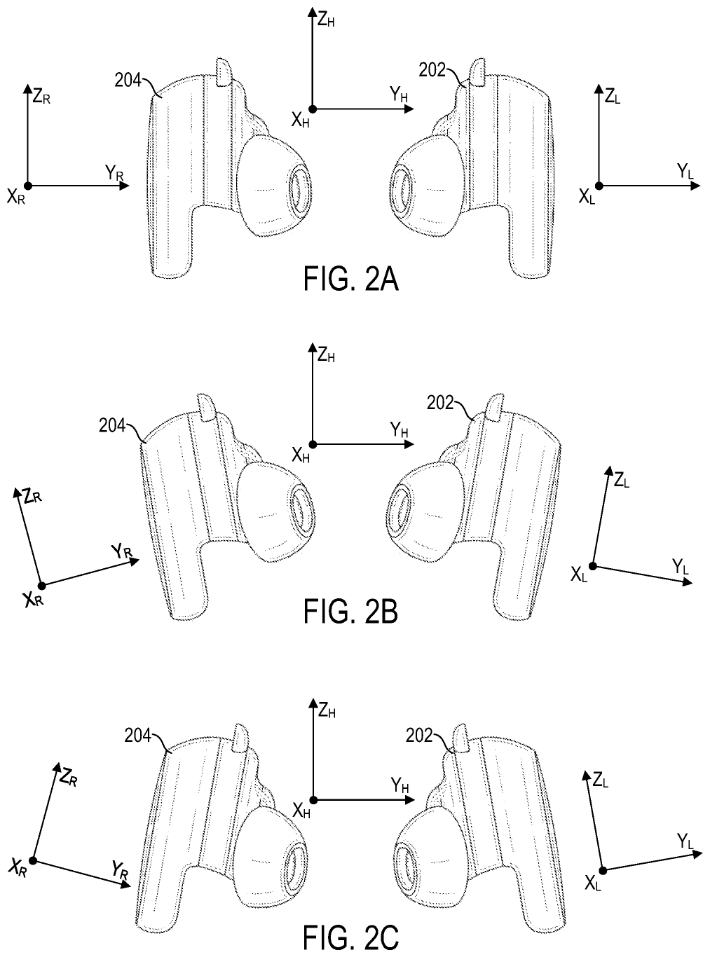

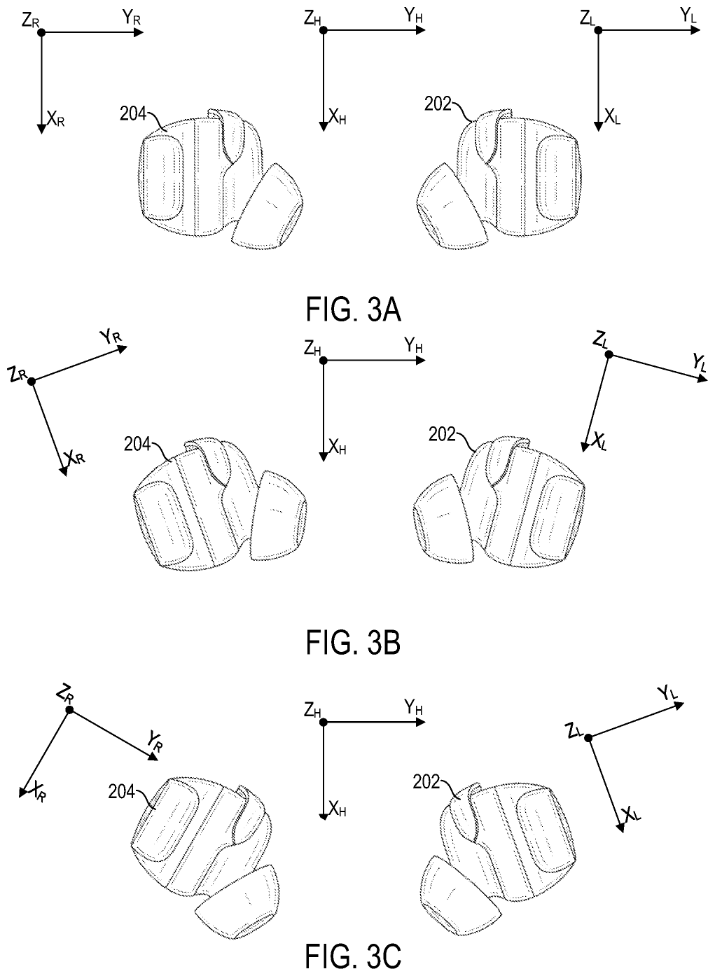

To accurately render the spatialized audio, the orientation sensors are used to accurately track changes in orientation of the user's head. This means that the axes of the orientation sensors must predictably mapped to axes of the user's head. FIGS. 1A and 1B show a front view and top view, respectively, of a user's head. FIGS. 1A and 1B further show the associated head axes, which, in this example, comprises the X_{H}, Y_{H}, and Z_{H} axes (in the view of FIG. 1A, X_{H} extends out of the page, and in the view of FIG. 1B, Z_{H} extends out of the page). Also shown, is the X_{H}-Z_{H} plane of head mirror symmetry. FIG. 2A depicts a pair of earbuds 202, 204 (in this example, Bose QuietComfort Earbuds II), in the aligned orientation when worn by a user. In this orientation, the axes of the orientation sensors disposed in earbuds 202, 204 align with the user's head axes. Specifically, the axes of the right earbud 204 (comprising axes X_{R}, Y_{R}, and Z_{R}) and of the left earbud 202 (comprising axes X_{L}, Y_{L}, and Z_{L}) are aligned with the axes of the user's head (X_{H}, Y_{H}, and Z_{H}) also shown in this view for reference. FIG. 3A likewise shows a top view of earbuds 202, 204 in the aligned alignment.

Users, however, do not always wear the earbuds in the aligned position. As shown in FIG. 2B, users will sometimes roll the earbuds 202, 204 outward, or, as shown in FIG. 2C, roll the earbuds 202, 204 inward. Alternatively, users will sometimes adjust the earphones inward in yaw, as shown in FIG. 3B, or outward as shown in FIG. 3C. (Users will also sometimes adjust the orientation of the earbuds in more than one way, such as by rolling the earbud inward and adjusting the yaw outward.) Although not shown, users can also adjust the pitch of the earbuds up or down. In each of these instances, at least two axes of the sensors cease to align with the user's head axes. For example, if the user rolls the earbuds in or out away from the position of FIG. 2A, the Y and Z axes of the earbuds cease to align with the Y_{H} and Z_{H} axes of the user's head. Similarly, if the user adjusts the yaw away from the position of FIG. 3A, the X and Y axes of the earbuds cease to align with the X_{H} and Y_{H} axes of the user's head.

This adjustment away from the user's head axes can result in the orientation sensors misinterpreting the motion of the user's head, diminishing the accuracy of the rendered spatialized audio. Motions of the user's head in one direction, such as pitch, will register in a change across different axes, such yaw or roll, resulting in an undesirable perception of the virtual source shifting in space.

Notably, however, the user often adjusts the earbuds in the same way in each ear, that is, anti-symmetrically about the X_{H}-Z_{H} mirror plane shown in FIGS. 1A and 1B. In other words, the adjustment to one earbud (202) is mirrored with the other earbud (204). (For the purpose of this disclose anti-symmetry is synonymous with mirror symmetry.) Thus, in FIGS. 3A and 3B, the pitch of earbuds 202, 204, whether inward or outward, is anti-symmetric about X_{H}-Z_{H} mirror plane. Likewise, in FIGS. 3B and 3C, whether the yaw of earbuds 202, 204 is adjusted inward or outward, the change is anti-symmetric about the X_{H}-Z_{H} mirror plane.

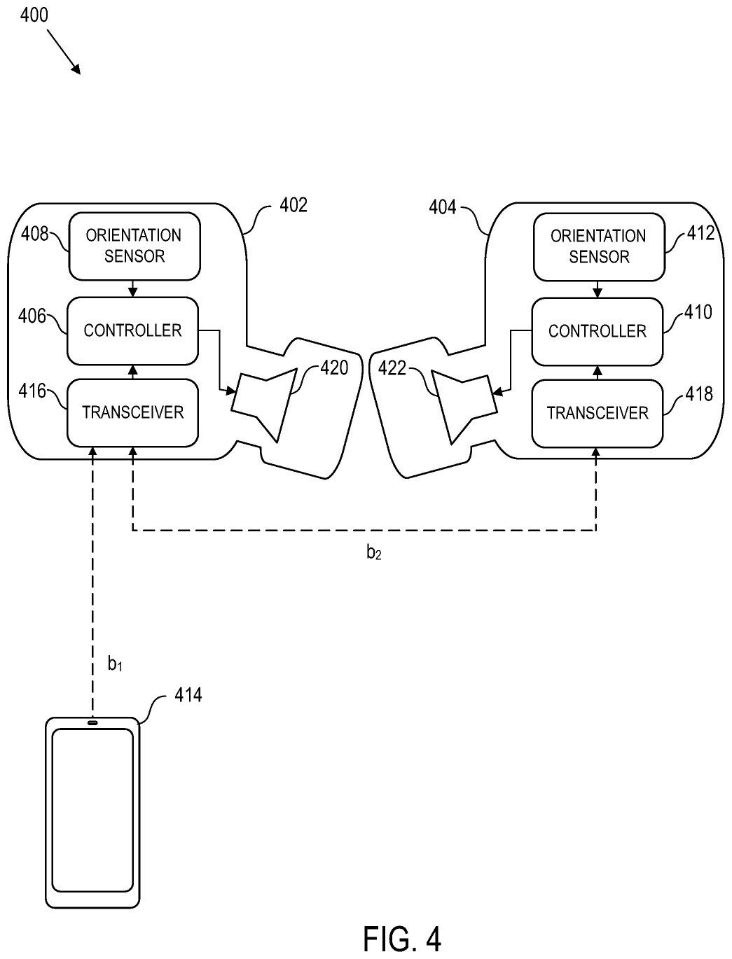

Turning to FIG. 4 there is shown a block diagram of a pair of earphones 400 with orientation sensor self-calibration for adjusting the axes of the orientation sensor in a manner that corrects anti-symmetrical misalignment. Earphones 400 comprise left earpiece 402 and right earpiece 404. Left earpiece 402 includes a controller 406 in communication with an orientation sensor 408, which detects an orientation of the left earpiece 402 and outputs an orientation signal, representative of the detected orientation, to controller 406. The orientation signal output from orientation sensor 408 is provided to controller 406 relative to the axes of orientation sensor 408. In other words, the orientation sensor 408 does not necessarily provide an absolute orientation, but a relative orientation that is given in terms of changes in the orthogonal axes of orientation sensor 408 as it rotates in space. Likewise, right earpiece 404 includes a controller 410 in communication with an orientation sensor 412, which detects and reports an orientation signal, representing the orientation of the right earpiece 404, to controller 410. The orientation signal output from orientation sensor 412 is provided to controller 410 relative to the axes of orientation sensor 412.

In the example of FIG. 4, left earpiece 402 and right earpiece 404 receive an audio signal from a source such as a mobile device 414 (although other suitable sources are contemplated). The audio signal is received at left earpiece 402, over wireless connection b₁ (e.g., a Bluetooth connection) at transceiver 416, which provides the audio signal to controller 406. Transceiver 416 further relays the audio signal to transceiver 418, via wireless connection b2 which provides the audio signal to controller 410. (In alternative examples, transceivers 416, 418 can each receive the wireless signal directly from the source, rather than relaying the signal to the other earpiece.) Controller 406 drives electroacoustic transducer 420 according to the audio signal received at transceiver 416, and controller 410 drives electroacoustic transducer 422 according to the audio signal received at transceiver 418. Controller 406 and controller 410 can drive electroacoustic transducers 420, 422 in a manner that provides a spatialized acoustic signal to the user, based on the orientation of the user's head detected by orientation sensors 408, 412. In general, the production of spatialized audio from an orientation signal is known and so a detailed explanation is omitted here. Any suitable spatialized audio algorithm can be used.

For the purposes of this disclosure, the term “earphones” refers to any wearables worn on the user's head that are susceptible to adjustment in a manner that would misalign the axes of the orientation sensor and the user's head, including both banded and non-banded examples. “Earphones” thus includes form factors such as on-ear headphones, over-ear headphones, in-ear headphones, earbuds, and open-ear headphones. Further, for the purposes of simplicity and to emphasize the more relevant aspects of earphones 400, certain features of the block diagram of FIG. 4 have been omitted, such as, for example, a battery, indicator LEDs, external buttons/inputs, feedback microphones, feedforward microphones, etc.

In addition, although a wireless connection to source 414, and between earpieces 402, 404 is described, in other examples, a wired connection can be used. The wired connection can, for example, connect to mobile device 414, or it can connect only earpieces 402, 404 together, such as within a neckband. To the extent that a wireless connection is used, any suitable wireless protocol can be employed. While Bluetooth or DECT are typically the standard for wireless headphone connections, it is conceivable that other standards, or a proprietary standard could be used. Transceivers 416, 418 can be implemented as wireless modules of the appropriate proprietary standard. For example, transceivers 416, 418 can each be implemented as a Bluetooth system-on-chip.

As will be described in detail below, to calibrate the orientation sensors 408, 412 a mapping between orientation sensors 408, 412 can be determined from the orientation signals. The axes of one of the orientation sensors (e.g., orientation sensor 408) can then by calibrated by rotating the axes of the orientation sensor to midpoint of the mapping between orientation sensors 408, 412. The axes of the other orientation sensor (e.g., orientation sensor 412) can be calibrated by rotating the axes to the inverse of the midpoint between the orientation sensors 408, 412. As a result, at least one of a roll or yaw of orientation sensor 408 axes and the orientation sensor 412 axes will more closely align with a user's head axis when the user is wearing the earpiece 402 and earpiece 404 anti-symmetrically about a mirror symmetry plane (i.e., the X_{H}-Z_{H} mirror symmetry plane of the user's head). Stated simply, by finding a rotation that splits the difference between the two orientation sensors 408, 412 and rotating the axes of one orientation sensor's frame counter to the direction the other sensor frame is rotated, the axes “meet in the middle” and eliminate any mirror-symmetric offsets. (This rotation can be encoded in any suitable manner, including a matrix, a quaternion, a vector and angle, etc.)

For the purposes of this disclosure, for the axes of a sensor to be aligned with the head axes means that motions of the user's head resulting in changes in orientation, in pitch, roll, or yaw, are accurately recorded and reported by the sensor as a change in pitch, roll, or yaw. If the axes are not aligned, such a change in the orientation of the user's head will not correspond to the same change in orientation reported by the orientation sensor.

For the purposes of this disclosure, a controller includes one or more processors and one or more non-transitory storage media and any associated hardware for performing the various functions described in this disclosure. In an example, a controller can comprise a microcontroller, which includes a processor and a non-transitory storage media. The controller can also comprise multiple microcontrollers acting in concert to perform the various functions described. Thus, in the example of FIG. 4, each of controller 406, 410 includes at least one processor and non-transitory storage medium storing program code that, when executed by the processor(s), provides the spatialized audio to acoustic transducers 420, 422, according to the outputs of orientation sensors 408, 412.

The calibration described in this disclosure, including the steps of method 500, can be performed by any suitable controller of earphones 400. Thus, in an example, the calibration can be performed by controller 406 or by controller 410. Indeed, the calibration can be performed by a combination of controllers 406 and 410 acting in concert. In this example, controllers 406, 410, working together, can be considered a single controller distributed between earpieces 402, 404. Further, in certain examples, the controller can be located outside of earpieces 402, 404. For example, in wired examples, a down-cable controller can perform the calibration. Indeed, it is conceivable that the calibration could be performed, at least in part, by a controller located outside of earphones 400, such as by mobile device 414, or even a remote server accessed over an internet connection.

Orientation sensors 408, 412 can be any comprised of any sensor or sensors outputting data from which an orientation of the sensor—i.e., three-dimensional axes of the sensor representing the sensor's orientation in space—can be determined. In an example, each orientation sensor 408, 412 can be an inertial measurement unit (IMU). An inertial measurement unit is a sensor that typically comprises accelerometers, gyroscopes, and sometimes magnetometers and outputs an orientation, acceleration, and angular velocity. An inertial measurement unit is, however, only one example of a suitable orientation sensor. In alternative examples, the orientation sensors can each comprise a plurality of gyroscope sensors, each gyroscope sensor outputting angular rate data in at least one axis, such that the angular rate of the earpiece in three dimensions can be determined. Further, the orientation sensor in each earpiece need not be the same type of sensor. For example, the orientation sensor can be an accelerometer disposed in one earpiece, and the orientation sensor can comprise an accelerometer and a gyroscope sensor in the other earpiece.

The orientation signals can comprise any suitable orientation data, including data representative of the orientation of the orientation sensor (and the earpiece to which it is attached) directly, e.g., as changes in pitch, roll, and yaw, or can contain other data from which orientation can be derived, such as the specific force and angular rate of the orientation sensor. Thus, as mentioned above, the orientation data can be encoded in a variety of ways, including a matrix, a quaternion, a vector and angle, etc. To the extent that the orientation sensor is comprised of multiple sensors, it should be understood that the orientation signal can comprise multiple signals. In one example, as mentioned above, the orientation signal can comprise data encoding a vector of angular rates. The vector of angular rates represents the change in orientation at given moment in time, i.e., the how quickly the orientation sensor is rotating about each of its three orthogonal axes (X, Y, and Z). In various alternative examples, the orientation signal can comprise data encoding a rotation vector, a game rotation vector, a geomagnetic rotation vector, or a quaternion. These forms will be understood and so a more detailed explanation of each is omitted here.

The mapping is a mathematical relationship (i.e., the difference) between the orientation of the orientation sensor 408 and orientation sensor 412, which, when applied to the axes of orientation sensor 408 yields the axes of orientation sensor 412. More particularly, because the orientation sensors 408, 412 are effectively attached to the same rigid body when they are placed in the user's ears, the orientation signals can be brought into agreement with a rotation matrix. Typically, the mapping will only work in a single direction. For example, a rotation matrix of the mapping will rotate the axes of orientation sensor 408 to the orientation of the axes of the orientation sensor 412, but the inverse rotation matrix will rotate the axes of orientation sensor 412 to match the orientation of orientation sensor 408. For the purposes of this disclosure, the mapping is generally described as rotating the orientation sensor 408 axes to the orientation of the orientation sensor 412 axes. This is, however, arbitrary. The mapping could equally be described in terms of rotating the orientation sensor 412 axes to the orientation of the orientation sensor 408 axes.

Further, applying the mapping to the orientation data of one of the sensors (e.g., orientation sensor 408) yields the orientation data of the other sensor (e.g., orientation sensor 412) for the same sample. Thus, for example, if the orientation data of each orientation sensor is represented as a vector of angular rates, the mapping, e.g., a rotation matrix, rotates the vector of angular rates of orientation sensor 408 to the orientation of orientation sensor 412. For example, the orientation data of the orientation sensor 408, for a single sample, can be represented as

$${ω}_{L} [ n ] = [ \begin{matrix}{ω}_{L , x} [ n ] \\ {ω}_{L , y} [ n ] \\ {ω}_{L , z} [ n ]\end{matrix} ] \qquad ( 1 )$$

where ω_{L}[n], the orientation data of orientation sensor 408, is a three-dimensional vector of angular rates including the angular rates in the direction of the x-axis ω_{L,x}[n], in the direction of the y-axis ω_{L,y}[n], and in the direction of the z-axis ω_{L,z}[n]. In the same way, the orientation data of the orientation sensor 408, for a single sample, can be represented as:

$${ω}_{R} [ n ] = [ \begin{matrix}{ω}_{R , x} [ n ] \\ {ω}_{R , y} [ n ] \\ {ω}_{R , z} [ n ]\end{matrix} ] \qquad ( 2 )$$

where ω_{R}[n], the orientation data of orientation sensor 412, is a three-dimensional vector of angular rates including the angular rates in the direction of the x-axis ω_{R,x}[n], in the direction of the y-axis ω_{R,y}[n], and in the direction of the z-axis ω_{R,z}[n]. Thus, the mapping can be expressed as a rotation vector R, as follows:

$$R {ω}_{L} [ n ] = {ω}_{R} [ n ] , ∀ n ϵℤ \qquad ( 3 )$$

(The notation ∀nε [symbol] means that the relationship of Eq. (3) is true for all integer values of n and should be assumed for the following equations (3)-(6), though not explicitly stated.) Conversely, the mapping can be expressed in terms of the inverse rotation matrix as applied to the right orientation data, as follows:

$${ω}_{L} [ n ] = {R}^{- 1} {ω}_{R} [ n ] \qquad ( 4 )$$

Alternatively, the mapping can be expressed as a unit quaternion Q, or as any suitable other rotation operator encoding a rotation.

Because both orientation sensor 408 and orientation sensor 412 are mounted to the same rigid body (i.e., the user's head) the same angular rates are observed by orientation sensor 408 and orientation sensor 412, and thus a rotation matrix exists that rotates the data from the orientation sensor 408 to yield the data of the right rotation matrix 412. (Although the equations in this disclosure are made with respect to a gyroscope sensor output of angular velocity, as will be readily apparent to a person of ordinary skill in the art, quaternions, or other similar outputs representing an orientation, could likewise be used and placed in a form to follow the methods set out herein.)

Once the mapping between orientation sensor 408 and orientation sensor 412 is determined, the axes of orientation sensor 408 and orientation sensor 412 can be calibrated according to the determined mapping. As described above, assuming that earpiece 402 and earpiece 404 are arranged on the user's head anti-symmetrically about the X_{H}-Z_{H} mirror symmetry plane in at least one of roll or yaw, the axes of the orientation sensor 408 and orientation 412 can be calibrated by adjusting the axes of one sensor (e.g., orientation sensor 408) to the midpoint of the mapping and the axes of the other sensor (e.g., orientation sensor 412) to inverse of the midpoint of the mapping. (Though there are technically two potential mappings between orientation sensor 408 and orientation sensor 412, the mapping that brings the sensor axes closest to the user's head (“in front of the user” instead of “behind the user”) is selected. Because of the details of how the axes are chosen in the product this corresponds to the “shortest rotation.”

Stated differently to remove any anti-symmetrical component of the orientation sensor axes, the axes of the orientation sensor 408 and the axes of the orientation sensor 412 can be calibrated by a rotation matrix that “splits the difference” between the sensors and rotates the axes of orientation sensor 408 counter to the direction that it rotates the axes of the orientation sensor 412. This can be represented according to the following equation:

$${R}_{m i d} {ω}_{L} [ n ] = {R}_{m i d}^{- 1} {ω}_{R} [ n ] \qquad ( 5 )$$

where R_{mid} is the midpoint of the rotation matrix R defined in equation (3). More particularly, rotation matrix R is the square of the midpoint rotation matrix R_{mid}. Conversely, R_{mid} is the root of rotation matrix R that rotates the axes of orientation sensor 408 to the orientation of orientation sensor 412. This can be observed in that Eq. (3) can be rewritten so that the square of midpoint rotation R²_{mid} rotates the data of orientation sensor 408 to the data of orientation sensor 412, in the same way as rotation matrix R:

$${R}_{m i d}^{2} {ω}_{L} [ n ] = {ω}_{R} [ n ] \qquad ( 6 )$$

The midpoint rotation matrix R_{mid} can be determined using a closed-form solution or iteratively (i.e., adaptively), as described below. Once the midpoint of the mapping is determined, the axes of orientation sensor 408 and orientation sensor 412 can be calibrated according to the determined midpoint. Determining the mapping is, thus, an intermediate step. Once the mapping is determined, it is assumed that the earphones are placed on a human head in a roughly mirror symmetric manner, and the head axes are therefore aligned with the midpoint of the mapping. Calibrating the axes of the orientation sensor 408 and orientation sensor 412, for the purposes of this disclosure, means adjusting the data output from the orientation sensor 408 and the orientation sensor 412 according to the rotation of the midpoint mapping or inverse midpoint mapping. As long as the earphones are earphones are disposed in a roughly mirror symmetric manner, the axes of orientation sensors 408 and 412, as a result of the calibration, will more closely align in at least one of roll or yaw and potentially both (though pitch misalignment can still persist). The calibration itself can be accomplished, for example, by adjusting the data output from the orientation sensor (e.g., at the controller(s)), or, if the orientation sensors have associated processors, the processor of the orientation sensor can perform the adjustment before being output to the controller.

Examples of the closed-form solution and the iterative solution will be briefly discussed. These are merely provided as examples of methods of finding the midpoint of the mapping that is used to calibrate the axes of the orientation sensors, and other examples could be used.

In an example of the closed-form solution, multiple samples of the angular velocity vectors can be employed to set up a least squares solution. Eq. 5 is true for all samples, so multiple samples can be stacked to form a matrix equation. Assuming the following:

$${W}_{L} = \begin{matrix}[ {ω}_{L} [ n ] & {ω}_{L} [ n + 1 ] & … & {ω}_{L} [ n + N ] ]\end{matrix} \qquad ( 7 )$$

$${W}_{R} = \begin{matrix}[ {ω}_{R} [ n ] & {ω}_{R} [ n + 1 ] & … & {ω}_{R} [ n + N ] ]\end{matrix} \qquad ( 8 )$$

Eq. 5 then becomes:

$${R}_{m i d}^{2} {W}_{L} = {W}_{R} \qquad ( 9 )$$

and, as long as the angular rate matrices have at least three independent samples, Rmid can be solved for as follows:

$${R}_{m i d}^{2} = {W}_{R} {{W}_{L}^{T} ( {W}_{L} {W}_{L}^{T} )}^{- 1} \qquad ( 10 )$$

Now that the square of the midpoint rotation matrix is found, the quaternion that corresponds to R_{mid} can be found by first finding the quaternion that corresponds to R²_{mid} and then the quaternion that rotates by half as much. In other words, the quaternion that corresponds to R²_{mid}, which can be denoted as qR²=[a, b, c, d], can be found. Next, the quaternion that rotates half as much as qR²_{mid} can be determined by:

$${q}_{Rmid} = [ cos ( θ / 2 ) , v sin θ / 2 ] \qquad ( 11 )$$

$$where θ = cos - 1 ( a ) and v = [ bcd ] / ‖ [ bcd ] ‖ .$$

The drawback with the closed-form solution is, however, that it is very difficult to guarantee that R²_{mid} will be a valid rotation matrix when the rate gyros have noise, gain errors, etc. The closed-form method, thus, while viable, is not very resilient. In an effort to compensate for an invalid rotation matrix, solutions could be employed to find the nearest valid rotation matrix, but this is computationally complicated because it requires that the matrix is an orthonormal unitary matrix—a constraint with no computationally efficient solutions.

Accordingly, using an iterative solution from Eq. 5, an error equation can be derived and its gradient computed in terms of the quaternion parameters to arrive at an update equation for the quaternion. The advantage of working directly in terms of the quaternion is that the constraint for it to correspond to a rotation is that it is unit length, a relative easy constraint to enforce compared to rotation matrix constraints. However, it should be understood that, in an alternative example, an update equation in terms of the rotation matrix can be used.

In this example, the error equation used to derive the iterative method is 2-norm of the misalignment,

$$e [ n ] = {( {R}_{mid} {ω}_{L} [ n ] - {R}_{mid}^{- 1} {ω}_{R} [ n ] )}^{T} ( {R}_{mid} {ω}_{L} [ n ] - {R}_{mid}^{- 1} {ω}_{R} [ n ] ) = {ω}_{L}^{T} {ω}_{L} [ n ] - {ω}_{R}^{T} [ n ] {R}_{mid}^{2} {ω}_{L} [ n ] - {ω}_{L}^{T} {R}_{mid}^{T} {R}_{mid}^{T} {ω}_{R} [ n ] + {ω}_{R}^{T} {ω}_{R} [ n ] = {ω}_{L}^{T} {ω}_{L} [ n ] - 2 {ω}_{R}^{T} [ n ] {R}_{mid}^{2} {ω}_{L} [ n ] + {ω}_{R}^{T} {ω}_{R} [ n ] \qquad ( 12 )$$

where, for rotation matrices, R⁻¹_{mid}=R^{T}_{mid}.

The rotation matrix can be written in terms of the quaternion parameters, q= [a, b, c, d]. The quaternion that corresponds to the square of the rotation matrix, as follows, can be used:

$${R}_{mid}^{2} = [ \begin{matrix}{a}^{2} + {b}^{2} - {c}^{2} - {d}^{2} & 2 bc - 2 ad & 2 bd + 2 ac \\ 2 bc + 2 ac & {a}^{2} - {b}^{2} + {c}^{2} - {d}^{2} & 2 cd - 2 ab \\ 2 bd - 2 ac & 2 cd + 2 ab & {a}^{2} + {b}^{2} - {c}^{2} - {d}^{2}\end{matrix} ] \qquad ( 13 )$$

This matrix can be substituted into the error equation and the gradient of the error equation can be computed with respect to the quaternion parameters,

$$∇ e [ n ] = [ \begin{matrix}{ω}_{R}^{T} [ n ] \frac{\partial ( {R}_{mid}^{2} )}{\partial a} {ω}_{L} [ n ] \\ {ω}_{R}^{T} [ n ] \frac{\partial ( {R}_{mid}^{2} )}{\partial b} {ω}_{L} [ n ] \\ {ω}_{R}^{T} [ n ] \frac{\partial ( {R}_{mid}^{2} )}{\partial c} {ω}_{L} [ n ] \\ {ω}_{R}^{T} [ n ] \frac{\partial ( {R}_{mid}^{2} )}{\partial d} {ω}_{L} [ n ]\end{matrix} ] \qquad ( 14 )$$

From Eq. 13. the partial derivatives are:

$$\frac{\partial ( {R}_{mid}^{2} )}{\partial a} = 2 [ \begin{matrix}a & - d & c \\ d & a & - b \\ - c & b & a\end{matrix} ] \qquad ( 15 )$$

$$\frac{\partial ( {R}_{mid}^{2} )}{\partial b} = 2 [ \begin{matrix}b & c & d \\ c & - b & - a \\ d & a & - b\end{matrix} ] \qquad ( 16 )$$

$$\frac{\partial ( {R}_{mid}^{2} )}{\partial c} = 2 [ \begin{matrix}- c & b & a \\ b & c & d \\ - a & d & - c\end{matrix} ] \qquad ( 17 )$$

$$\frac{\partial ( {R}_{mid}^{2} )}{\partial d} = 2 [ \begin{matrix}- d & - a & b \\ a & - d & c \\ b & c & d\end{matrix} ] \qquad ( 18 )$$

In the above matrices, there are only four linearly independent rows, so the number if computations can be reduced significantly. The following intermediate variables can be used:

$${y}_{1} [ n ] = [ \begin{matrix}a & - d & c\end{matrix} ] {ω}_{L} [ n ] \qquad ( 19 )$$

$${y}_{2} [ n ] = [ \begin{matrix}d & a & - b\end{matrix} ] {ω}_{L} [ n ] , \qquad ( 20 )$$

$${y}_{3} [ n ] = [ \begin{matrix}- c & b & a\end{matrix} ] {ω}_{L} [ n ] , \qquad ( 21 )$$

$${y}_{4} [ n ] = [ \begin{matrix}b & c & d\end{matrix} ] {ω}_{L} [ n ] . \qquad ( 22 )$$

In terms of the intermediate variables, the error gradient can be written as

$$∇ e [ n ] = [ \begin{matrix}{y}_{1} [ n ] & {y}_{2} [ n ] & {y}_{3} [ n ] \\ {y}_{4} [ n ] & - {y}_{3} [ n ] & {y}_{2} [ n ] \\ {y}_{3} [ n ] & {y}_{4} [ n ] & - {y}_{1} [ n ] \\ - {y}_{2} [ n ] & {y}_{1} [ n ] & {y}_{4} [ n ]\end{matrix} ] {ω}_{R} [ n ] \qquad ( 23 )$$

The update equation for the adaptation, in an example, is:

$$q [ n + 1 ] = q [ n ] - μ ∇ e [ n ] \qquad ( 24 )$$

where μ is a design parameter that trades-off between fast convergence and a smoother estimate. If u is set too high, the algorithm can produce noisy results and even become unstable.

The last step of the iteration is to normalize q so that it has unit length which constrains it to correspond to a pure rotation. The q that results from this method corresponds to R²_{mid}, though R_{mid} is the target. After the algorithm has converged, the same technique described in Eq. (11) can be used to determine R_{mid}. Particularly, denoting the quaternion resulting from the iterative method as q=[a, b, c, d], then the quaternion that rotates by half as much is:

$${q}_{Rmid} = [ cos ( θ / 2 ) , v sin θ / 2 ] \qquad ( 26 )$$

In simulation, the algorithm convergences on the order of a second, which is satisfactory, but if the convergence rate is still too slow, it would be possible to make the step direction second order by including the Jacobian of the error. It is likely that this would be very simple, as the gradient is linear in the quaternion parameters, the Jacobian will be constant values. The iterative method can be setup to directly solve for the quaternion that corresponds to R_{mid}, but the equation for the error gradient involves several more matrix multiplications so it is not nearly as efficient.

Further, it should be understood that any suitable adaptive equation can be used. Thus, while the above example was described in terms of a least-mean squares adaptive algorithm, other adaptive algorithms, such as recursive least squares, could be used.

In addition, the mapping can be determined from disparate types of orientation sensor. For example, rather than orientation sensor 408, 412 each comprising inertial measurement units or each comprising gyroscopes, sensor 408 can comprise an accelerometer and a gyroscope and sensor 412 can comprise an accelerometer. (In another example, sensor 408 can comprise an accelerometer and sensor 412 can comprise an accelerometer and a gyroscope.) It will be understood that these types of sensors can be employed as standalone sensors or constituent members of another type of sensor, such as an inertial measurement unit, which, as described above, typically includes accelerometers and gyroscopes.

To use accelerometers, however, requires eliminating a gravity term that is inherent to their output signal. This can be accomplished in any number of ways, including by relating the measurements of the left and right accelerometer signals by the rigid body equation, as described below. Accelerometers also inherently have a bias that must be eliminated by, for example, taking the derivative of the accelerometer signals or by applying a high-pass filter, as the bias is approximately constant.

The left accelerometer signal (i.e., the signal from accelerometer of sensor 408) can be represented as follows:

$${accel}_{L} = {a}_{L} - {[ g ]}_{{C}_{L}} + {b}_{{a}_{L}} + {n}_{{a}_{L}} \qquad ( 27 )$$

where a_{L} is the measured linear acceleration, −[g]_{C}_{_{L}} is the reaction of the accelerometer to gravity (the subscript C_{L} represents the coordinate system of the left accelerometer), bₐ_{_{L}} is a bias of the accelerometer, and na, is noise (which is omitted in the equations that follow). Likewise, the right accelerometer signal (i.e., the signal from accelerometer of sensor 412) can be represented as:

$${accel}_{R} = {a}_{R} - {[ g ]}_{{C}_{R}} + {b}_{{a}_{R}} + {n}_{{a}_{R}} \qquad ( 28 )$$

where a_{R} is the measured linear acceleration, −[g]_{C}_{_{R}} is the reaction of the accelerometer to gravity (the subscript C_{L} represents the coordinate system of the right accelerometer), bₐ_{_{R}} is a bias of the accelerometer, and nₐ_{_{R}} is noise (which is omitted in the equations that follow).

To determine the mapping (which, again, can be encoded as, e.g., a rotation matrix R or a unit quaternion Q as described above) the outputs of sensors 408 and 412 can first be related according to the rigid body equation. For example, the linear acceleration of the right accelerometer can be expressed in the left coordinate system C_{L} at the point in space of the left accelerometer, as follows:

$${a}_{R} = {a}_{L} + \dot{ω} \times r + ω \times ( ω \times r ) \qquad ( 29 )$$

where aR is the acceleration at point O_{R} (i.e., point in space of orientation sensor 412) expressed in terms of acceleration at point O_{L} (the point in space of orientation sensor 408), ω is the angular velocity as measured by the left gyroscope, and r is the vector that translates from point O_{L} to point O_{R}. More specifically, r can be written as:

$$r = \vec{{O}_{L} {O}_{R}} \qquad ( 30 )$$

Eq. (29) can be rewritten as

$${[ {a}_{R} ]}_{{C}_{L}} = {[ {a}_{L} ]}_{{C}_{L}} + {S}_{{[ \dot{ω} ]}_{{C}_{L}}} \cdot {[ r ]}_{{C}_{L}} + {S}_{{[ ω ]}_{{C}_{L}}}^{2} \cdot {[ r ]}_{{C}_{L}} \qquad ( 31 )$$

Where the subscript C_{L} is used to highlight that the coordinate system of the left accelerometer is used, and S_{ω} is a skew-symmetric matrix given by

$${S}_{ω} = [ \begin{matrix}0 & - {ω}_{3} & {ω}_{2} \\ {ω}_{3} & 0 & - {ω}_{1} \\ - {ω}_{2} & {ω}_{1} & 0\end{matrix} ] \qquad ( 32 )$$

Next, taking measurements from the left accelerometer and left gyroscope (of sensor 408) and the right accelerometer (of sensor 412) yields the following measured terms [accel_{L}]_{C}_{_{L}}, [ω]_{C}_{_{L}}, [\dot{ω}]_{C}_{_{L}}, [g]_{C}_{_{L,0}} (reaction of the left accelerometer to gravity at time t₀, i.e., the initialization of the accelerometer), [accel_{R}]_{C}_{_{R}}. From this, a rotation matrix R_{L} (or a quaternion q_{L}), that encodes the rotation from C_{L,0} to C_{L}, i.e., from the sensor 408 frame at initialization to the current frame (or another subsequent frame, provided that the same subsequent frame is used throughout).

Using these measured values, and the rigid body equation, Eq. (31), can be rewritten as follows:

$$R \cdot {[ {accel}_{R} ]}_{{C}_{R}} + {R}_{L}^{T} \cdot {[ g ]}_{{C}_{L , 0}} - R \cdot {[ {b}_{{a}_{R}} ]}_{{C}_{R}} = {[ {accel}_{L} ]}_{{C}_{L}} + {R}_{L}^{T} \cdot {[ g ]}_{{C}_{L , 0}} - {[ {b}_{{a}_{L}} ]}_{{C}_{L}} + ( {S}_{{[ \dot{ω} ]}_{{C}_{L}}} + {S}_{{[ ω ]}_{{C}_{L}}}^{2} ) \cdot {[ r ]}_{{C}_{L}} \qquad ( 33 )$$

In Eq. (33), on the left-hand side, right linear acceleration [a_{R}]_{C}_{_{L}}, has been replaced with the expression

$$R \cdot {[ {accel}_{R} ]}_{{C}_{R}} + {R}_{L}^{T} \cdot {[ g ]}_{{C}_{L , 0}} - R \cdot {[ {b}_{{a}_{R}} ]}_{{C}_{R}} ,$$

where. On the right-hand side, the [a_{L}]_{C}_{_{L}} has been replaced with the expression

$${[ {accel}_{L} ]}_{{C}_{L}} + {R}_{L}^{T} \cdot {[ g ]}_{{C}_{L , 0}} - {[ {b}_{{a}_{L}} ]}_{{C}_{L}} .$$

Notably, in Eq. (33), the gravity term R_{L}^{T}. [g]_{C}_{_{L,0}}, appears on both the left and right hand side, and thus cancels. Consequently, Eq. (33) can be simplified and rewritten:

$$R \cdot {acc}_{R} = {acc}_{L} + ( {S}_{\dot{ω}} + {S}_{ω}^{2} ) \cdot r + {B}_{a} \qquad ( 34 )$$

where the following substitutions have been made: r=[r]_{C}_{_{L}}, ω=[ω]_{C}_{_{L}}, \dot{ω}=[\dot{ω}]_{C}_{_{L}}, acc_{L}=[accel_{L}]_{C}_{_{L}}, aCC_{R}=[accel_{R}]C_{R}, and

$${B}_{a} = {[ {b}_{{a}_{R}} ]}_{{C}_{L}} - {[ {b}_{{a}_{L}} ]}_{{C}_{L}} = R \cdot {[ {b}_{{a}_{R}} ]}_{{C}_{R}} - {[ {b}_{{a}_{L}} ]}_{{C}_{L}} .$$

From this equation, the rotation matrix R, the vector r, and the combined bias terms Bₐ remain unknowns.

In either sensor frame, C_{R} or C_{L} biases are constant (very slowly varying): Bₐ is thus approximately constant across measurements. The bias term Bₐ can therefore be eliminated by taking the derivative of both sides of equation (34), csomponent-wise, yielding:

$$R \cdot ( {\dot{acc}}_{R} ) = ( {\dot{acc}}_{L} ) + ( {S}_{\ddot{ω}} + {S}_{\dot{ω}} \cdot {S}_{ω} + {S}_{ω} \cdot {S}_{\dot{ω}} ) \cdot r \qquad ( 35 )$$

with: \dot{B}ₐ=R·\dot{b}ₐ_{_{R}}−\dot{b}ₐ_{_{L}}≅0. Equation (35) cannot be interpreted purely as the relation between vectors with physical meaning, because the vector derivative is not taken in a moving frame. Instead, the component-wise derivative of the signals is taken to eliminate the constant bias.

Alternatively, biases can be removed by applying a high-pass filter, H, to each side of Eq. (34), which can result in less noise than taking the derivative:

$$R \cdot {Hacc}_{R} = {Hacc}_{L} + ( H ( {S}_{\dot{ω}} + {S}_{ω}^{2} ) ) \cdot r \qquad ( 36 )$$

Eq. (36) can be simplified further. With the gravity and bias terms canceled and eliminated, −HaCC_{R}=Ha_{R} and Hacc_{L}=Ha_{L}. By calling the expression S_{\dot{ω}}+S_{ω}², U_{ω}, Eq. (36) can be rewritten as:

$$R \cdot {Ha}_{R} = {Ha}_{L} + {HU}_{ω} \cdot r \qquad ( 37 )$$

In either case (taking the derivative or using the high-pass filter) with the gravity terms and biases removed, the two remaining unknowns, R and r, can be solved for according to any suitable method. For example, (using the high-pass filter example), Eq. (37) can be written as an optimization problem, where R and r are jointly optimized for:

$$J ( R , r ) = {\sum }_{t} {\vert {Ha}_{L , t} + {HU}_{ω , t} \cdot r - R \cdot {Ha}_{R , t} \vert}_{t}^{2} \qquad ( 38 )$$

Adding a constraint that R must be a rotation matrix yields:

$$J ( R , r , λ ) = {\sum }_{t} {\vert {Ha}_{L , t} + {HU}_{ω , t} \cdot r - R \cdot {Ha}_{R , t} \vert}_{t}^{2} - λ \vert {R}^{T} \cdot R - Id \vert \qquad ( 39 )$$

The global optimization problem can be rewritten using quaternions. Thus, rather than optimizing for R, the optimization problem can be rewritten to optimize for a quaternion Q that encodes the same rotation as R. To do this, Ha_{L,t}, Ha_{R,t}, r, HU_{ω,t} can be modified to be compatible with quaternion operations:

$${Ha}_{L , t} = [ 0 , {Ha}_{LX , t} {Ha}_{LY , t} , {Ha}_{LZ , t} ] , \\ {Ha}_{R , t} = [ 0 , {Ha}_{RX , t} {Ha}_{RY , t} , {Ha}_{RZ , t} ] , r = [ 0 , {r}_{X} , {r}_{Y} , {r}_{Z} ]$$

$${HU}_{ω , t} = [ \begin{matrix}0 & {0}_{3}^{T} \\ {0}_{3} & {HU}_{ω , t}\end{matrix} ] , where {0}_{3} = [ 0 , 0 , 0 ]$$

From this, as will be understood by a person of ordinary skill in the art, at least two different methods, a least-squares method and a gradient descent method can be used to solve for R and r. The first of these, the least-squares example, Q and r can be found, with the constraint that Q is a unit quaternion according to the following equation:

$$J ( Q , r , λ ) = {\sum }_{t} {\vert {Ha}_{L , t} + {HU}_{ω , t} \cdot r - Q \cdot {Ha}_{R , t} \cdot {Q}^{*} \vert}_{t}^{2} - λ ( {Q}^{*} \cdot Q - 1 ) \qquad ( 40 )$$

The second of these examples, the gradient descent, can be found of the cost function J(Q,r):

$$J ( Q , r ) = {\sum }_{t} {\vert {Ha}_{L , t} + {HU}_{ω , t} \cdot r - Q \cdot {Ha}_{R , t} \cdot {Q}^{*} \vert}_{t}^{2} \qquad ( 41 )$$

To calculate the gradient descent, a starting point (Q₀, r₀) is chosen, and the gradient of J is calculated at each step: ∇J(Qₙ, rₙ). This is updated with u:

$$[ \begin{matrix}{Q}_{n + 1} \\ {r}_{n + 1}\end{matrix} ] = [ \begin{matrix}{Q}_{n} \\ {r}_{n}\end{matrix} ] - μ ∇ J ( {Q}_{n} , {r}_{n} ) ,$$

while enforcing the constraint that Qₙ₊₁ encodes a rotation by normalizing:

$${Q}_{n + 1} ← \frac{{Q}_{n + 1}}{\vert {Q}_{n + 1} \vert} .$$

Once the mapping (rotation matrix R or quaternion Q) has been found, the method can progress as described above, i.e., by calculating the midpoint of the rotation matrix, applying the midpoint to one of the sensors (e.g., sensor 408) and applying the inverse of the midpoint to the other sensor (e.g., sensor 412).

Additionally, the vector r, representing the vector between orientation sensor 408 and orientation sensor 412, can be used to inform the interaural time difference of the spatial algorithm. The interaural time difference is a known parameter of spatialized audio algorithms that represents the difference in arrival time of sound between the user's ears. The difference in arrival time will be related to the size of the user's head, i.e., the distance between the user's ears, of which the vector r is representative. Accordingly, the vector r can be used as an input to the spatialized audio algorithm as an estimate of the distance between the user's ears to inform the interaural time difference parameter. By more accurately measuring the distance between the user's ears, the spatialized audio performance can be improved.

Although the vector r is described above as relating the distance between accelerometers specifically, it should be understood that any suitable orientation sensor outputs can be used. Specifically, any suitable orientation sensor outputs can be related by the rigid body equation, which can be solved to yield the vector r, according to the example described above.

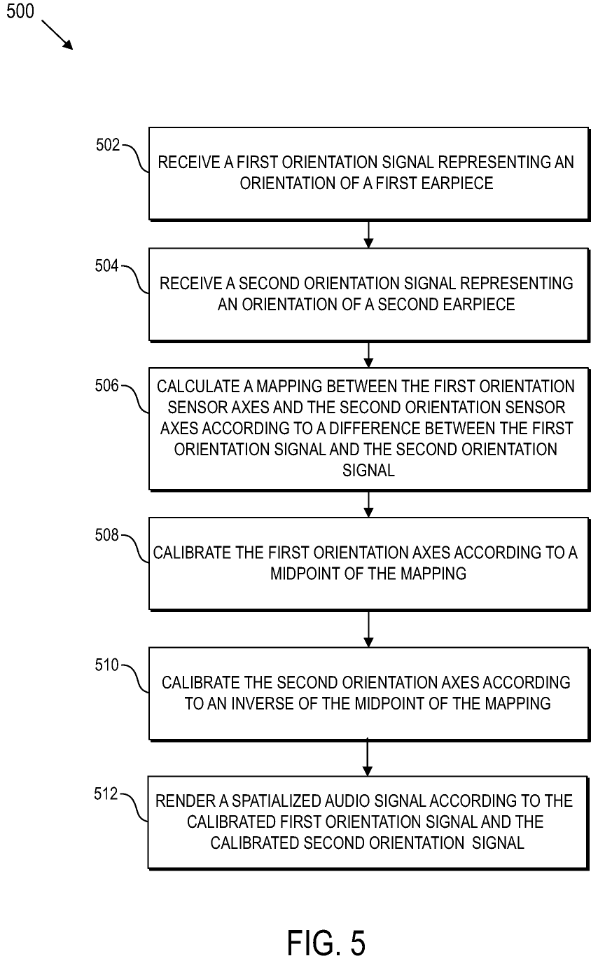

FIG. 5 depicts a flowchart of a method for calibrating the axial alignment of orientation sensors. The steps of method 500 can be accomplished by a controller as described above, such as controllers 406, 410 or a controller that is comprised of both controllers 406, 410 acting in concert. As such, in an example, the steps of method 500 can be accomplished by one or more processors executing program code stored in one or more non-transitory storage media. For the purposes of this method, the earpieces will be described as a “first” and a “second” earpiece. This is to emphasize that the method does not depend on either the left or right earpieces performing a particular step. Thus, the left earpiece can be the first earpiece and the right the second; alternatively, the right earpiece can be the first earpiece and the left the second.

At step 502, a first orientation signal representing an orientation of a first earpiece is received. The first orientation signal is received from an orientation sensor disposed in a first earpiece. At step 504, receive a second orientation signal representing an orientation of a second earpiece. The second orientation signal is received from an orientation sensor disposed in a second earpiece.

The first and second orientation sensors, as described above, can be any comprised of any sensor or sensors outputting data from which an orientation of the sensor-i.e., the three-dimensional axes of the sensor representing the sensor's orientation in space-can be determined. Examples of sensors include inertial measurement units or a plurality of gyroscope sensors. Further, the sensors include disparate sensor types, such as an accelerometer and a gyroscope in one earpiece and an accelerometer in another earpiece.

The orientation signals can comprise data representative of the orientation of the orientation sensor (and the earpiece to which it is attached) directly, e.g., as changes in pitch, roll, and yaw, or can contain other data from which orientation can be derived, such as the specific force and angular rate of the orientation sensor. The orientation signal output from the first orientation sensor orientation is relative to the axes of the first orientation sensor. In other words, the first orientation sensor does not necessarily provide an absolute orientation, but a relative orientation that is typically provided in terms of changes in the orthogonal axes of the first orientation sensor as it rotates in space. Likewise, the orientation signal output from the second orientation sensor is provided to controller is relative to the axes of orientation sensor.

To the extent that the orientation sensor is comprised of multiple sensors, it should be understood that the orientation signal can comprise multiple signals. In various alternative examples, the orientation signal can comprise data encoding a rotation vector, a game rotation vector, a geomagnetic rotation vector, or a quaternion.

At step 506, a mapping between the first orientation sensor axes and the second orientation sensor axes according to a difference between the first orientation signal and the second orientation signal. The mapping (e.g., as expressed by a rotation matrix in Eq. (3)) is a mathematical relationship (i.e., the difference) between the orientation of the first orientation sensor and the second orientation sensor. The mapping, when applied to the axes of first orientation sensor yields the axes of the second orientation sensor. Because the first and second orientation sensors are effectively attached to the same rigid body when placed in the user's ears, the orientation signals can be brought into agreement with a rotation matrix. Typically, the mapping will only work in a single direction. For example, the rotation matrix of the mapping will rotate the axes of the first orientation sensor to the orientation of the axes of the second orientation sensor, but the inverse rotation matrix will rotate the axes of second orientation sensor to match the orientation of the first orientation sensor. Applying the mapping to the orientation data of the first orientation sensor yields the orientation data of the second orientation sensor for the same sample.

The mapping (or the midpoint of the mapping) can be determined using a closed-form solution (an example of which is described above in connection with Eqs. (1)-(10)) or iteratively (i.e., adaptively) (an example of which is describe above in connection with Eqs. (12)-(24)). The adaptive algorithm used can be any suitable adaptive algorithm including least mean squares or recursive lease squares. Further, the adaptive algorithm can find the midpoint mapping, in various examples, in terms of a quaternion or a rotation matrix. If the disparate sensor types describe above-an accelerometer and gyroscope as one sensor and an accelerometer as the other sensor—is used, this can be performed according to the example described above in connection with Eqs. (27)-(41).

At step 508, the first orientation axes are calibrated according to a midpoint of the mapping. Calibrating the axes of the first orientation sensor can be accomplished by adjusting the data output from the orientation sensor such that it aligns with the axes of the first orientation sensor as rotated by the midpoint mapping (as described above, in terms of a rotation matrix, in connection with Eq. (5)). This can be implemented, for example, by adjusting the data output from the first orientation sensor, or, if the first orientation sensor has an associated processor, the processor of the first orientation sensor can perform the adjustment before being output. The midpoint mapping can be determined from the mapping determined in step 506, e.g., as described above in connection with Eqs. (11) and (26).

At step 510, the second orientation axes are calibrated according to an inverse of the midpoint of the mapping. Calibrating the axes of the second orientation sensor, like the first orientation sensor, can be accomplished by adjusting the data output from the second orientation sensor such that it aligns with the axes of the second orientation sensor as rotated by the inverse midpoint mapping (as described above, in terms of a rotation matrix, in connection with Eq. (5)). This can be implemented, for example, by adjusting the data output from the second orientation sensor, or, if the second orientation sensor has an associated processor, the processor of the second orientation sensor can perform the adjustment before being output. The midpoint mapping can be determined from the mapping determined in step 506, e.g., as described above in connection with Eqs. (11) and (26).

At step 512, a spatialized audio signal is rendered according to the calibrated first orientation signal and the calibrated second orientation signal. That is, the spatialized audio signal is rendered according to the first orientation signal, rotated according to the midpoint of the mapping between the orientation sensors, and the according to the second orientation signal, rotated according to the inverse of the midpoint of the mapping between the orientation sensors. The spatialized audio signal, as will be understood, comprises the left audio signal delivered to the acoustic transducers in the left earpiece and the right audio signal delivered to the acoustic transducers in the right earpiece. The spatialized audio signal, delivered to the acoustic transducers of the earpieces, results in the transduction of a spatialized acoustic signal that is perceived by the user as originating from at least one location distinct from the transducers.

The production of the spatialized audio signal can be accomplished by any suitable spatialized audio algorithm, as are known in the art. Additionally, the vector r, as described above, can be determined according to the rigid body equation and the outputs of the orientation sensors, represents the distance between the orientation sensors, and, by extension, the distance between the user's ears. This value can be used to inform (i.e., adjust) the interaural time difference of the spatial algorithm. As described above, the interaural time difference is a known parameter of spatialized audio algorithms that represents the difference in arrival time of sound between the user's ears. The difference in arrival time will be related to the size of the user's head, i.e., the distance between the user's ears, of which the vector r is representative. Accordingly, the vector r can be used as an input to the spatialized audio algorithm as an estimate of the distance between the user's ears to inform the interaural time difference parameter. By more accurately measuring the distance between the user's ears, the spatialized audio performance can be improved.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. A pair of earphones with orientation sensor axial alignment self-calibration, comprising:
a first earpiece housing a first orientation sensor, the first orientation sensor outputting a first orientation signal, wherein the first orientation signal is representative of an orientation of the first earpiece and is relative a first orientation axes of the first orientation sensor;
a second earpiece housing a second orientation sensor, the second orientation sensor outputting a second orientation signal, wherein the second orientation signal is representative of an orientation of the second earpiece and is relative to a second orientation axes of the second orientation sensor;
and a controller configured to calculate a mapping between the first orientation sensor axes and the second orientation sensor axes according to a difference between the first orientation signal and the second orientation signal, wherein the controller is further configured to calibrate the first orientation axes according to a midpoint of the mapping and calibrate the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

2. The pair of earphones of claim 1, wherein the mapping is calculated according to an adaptive algorithm.

3. The pair of earphones of claim 1, wherein the mapping is calculated non-adaptively.

4. The pair of earphones of claim 1, wherein the first orientation sensor and the second orientation sensor are each inertial measurement units.

5. The pair of earphones of claim 1, wherein the first orientation sensor and the second orientation sensor each comprise at least gyroscope sensor.

6. The pair of earphones of claim 1, wherein the first orientation sensor is an accelerometer and a gyroscope sensor, wherein the second orientation sensor is a gyroscope sensor . . .

7. The pair of earphones of claim 1, wherein the controller is housed in at least one of the first earpiece or the second earpiece.

8. The pair of earphones of claim 1, wherein the controller is further configured to render a spatialized audio signal according to the calibrated first orientation signal and the calibrated second orientation signal.

9. The pair of earphones of claim 8, wherein the spatialized audio signal is determined according to a spatialized audio algorithm, the spatialized audio algorithm including an interaural time difference parameter, wherein the controller is further configured to adjust the interaural time difference parameter according to a vector representing a distance between the first orientation sensor and the second orientation.

10. A method for calibrating the axial alignment of orientation sensors, comprising:
receiving a first orientation signal representative of an orientation of a first earpiece of a pair of earphones, the first orientation signal being relative a first orientation axes of a first orientation sensor;
receiving a second orientation signal representative of an orientation of a second earpiece of the pair of headphones, the second orientation signal being relative a second orientation axes of a second orientation sensor;
calculating a mapping between the first orientation sensor axes and the second orientation sensor axes according to a difference between the first orientation signal and the second orientation signal;
calibrating the first orientation axes according to a midpoint of the mapping; and
calibrating the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

11. The method of claim 10, wherein the mapping is calculated according to an adaptive algorithm.

12. The method of claim 10, wherein the mapping is calculated non-adaptively.

13. The method of claim 10, wherein the first orientation sensor and the second orientation sensor are each inertial measurement units.

14. The method of claim 10, wherein the first orientation sensor and the second orientation sensor each comprise at least one gyroscope sensor.

15. The method of claim 10, wherein the first orientation sensor is an accelerometer and a gyroscope sensor, wherein the second orientation sensor is an accelerometer.

16. The method of claim 10, further comprising:
rendering a spatialized audio signal according to the calibrated first orientation signal and the calibrated second orientation signal, wherein the spatialized audio signal is determined according to a spatialized audio algorithm, the spatialized audio algorithm including an interaural time difference parameter, and
adjusting the interaural time difference parameter according to a vector representing a distance between the first orientation sensor and the second orientation.

17. At least one non-transitory storage medium storing program code for execution on at least one processor that, when executed, calibrates the axial alignment of a pair of orientation sensors, comprising:
receiving a first orientation signal representative of an orientation of a first earpiece of a pair of earphones, the first orientation signal being relative a first orientation axes of the first orientation sensor;
receiving a second orientation signal representative of an orientation of a second earpiece of the pair of headphones, the second orientation signal being relative a second orientation axes of a second orientation sensor;
calculating a mapping between the first orientation sensor axes and the second orientation sensor axes according to a difference between the first orientation signal and the second orientation signal;
calibrating the first orientation axes according to a midpoint of the mapping; and
calibrating the second orientation axes according to an inverse of the midpoint of the mapping such that at least one of a roll and yaw of the first orientation sensor axes and the second orientation sensor axes more closely align with a user's head axis when the user is wearing the first earpiece and the second earpiece anti-symmetrically about at least one mirror symmetry plane of the user's head.

18. The non-transitory storage medium of claim 17, wherein the mapping is calculated according to an adaptive algorithm.

19. The non-transitory storage medium of claim 17, wherein the mapping is calculated non-adaptively.

20. The non-transitory storage medium of claim 17, wherein the first orientation sensor and the second orientation sensor are each inertial measurement units.
